(19) United States
(12) Patent Application Publication
(10) Pub. No.: US 2004/0222362 A1
(43) Pub. Date: Nov. 11, 2004

(54) Procedure and sensor device for detecting colors

(76) Inventors: Thomas Zelenka, Monkeberg (DE); Wolfgang Eberhard Luxem, Kiel (DE); Marion Gabriele Behrens, Kiel (DE)

Correspondence Address: Lawrence P. Kessler, Patent Department, NexPress Solutions LLC, 1447 St. Paul Street, Rochester, NY, 14653-7103, US

(21) Appl. No.: 10/822,324

(22) Filed: Apr. 12, 2004

(30) Foreign Application Priority Data
Apr. 16, 2003 (DE) 103 17 447.8

(51) Int. Cl. G01J 3/50; H01J 5/16; G01N 21/86

(52) U.S. Cl. 250/226; 250/559.38

(57) ABSTRACT

Detecting various colors on a surface, whereby a varying distance between a sensor device and the surface is detected, and the sensor device's signals are functionally linked to the varying distance. Measurement of the surface using the sensor device serves the purpose of both detecting the color and detecting the distance between the sensor device and the surface. The color value of the surface is determined depending on the distance of the surface from the sensor device.

### FIELD OF THE INVENTION

This invention relates in general to sensing colors on a surface, and more particularly to color sensing where the distance to the color-bearing surface is used in determining the color on the surface.

### BACKGROUND OF THE INVENTION

A rising trend in the printing industry is the use of multi-color printing instead of black-and-white printing. In color printing, it is very important to apply toner onto the print material in color-true fashion, with higher quality standards being demanded for the finished product. To test the desired color of the printed result, color tests are conducted. In order to conduct color tests, an option to use color sensors exists. Specifically, if the color on the printed material is determined during the printing process, slight changes in the distance between the color sensor and the print material occur. These interval changes cause errors in the color sensor's determination of color values.

### SUMMARY OF THE INVENTION

In view of the above, this invention is directed to determining the color value of the surface, which depends on the distance of the surface from the sensor. This way, the color value of the surface can be determined with precision and accurate formulation of a color on a surface can occur.

In one embodiment of this invention, the sensor emits white light to the color-bearing surface. The reflected light is spectrally separated by a filter, and is received by a sensor receiver. Correction values in a color-value allotment table are determined from the calculated distance between the surface and the sensor, so that an error-free color value is available rapidly and simply. The intensity of the light irradiated to a surface, and properly stored in an allotment table is changed, depending on the distance of the surface from the sensor device. This allows the sensor device to adapt to changes in the distance from the surface to the sensor device, obviating the need for constant determination of the distance.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawings, in which:

FIG. 1 shows a schematic embodiment form of the invention with irradiation of a color-bearing surface by white light and spectral splitting of the light, reflected on the surface;

FIG. 2 is a schematic block-diagram depiction of the information processing, when color values are corrected; and

FIG. 3 is a schematic block-diagram depiction of multi-channel information processing, in correcting color values.

### DETAILED DESCRIPTION OF THE INVENTION

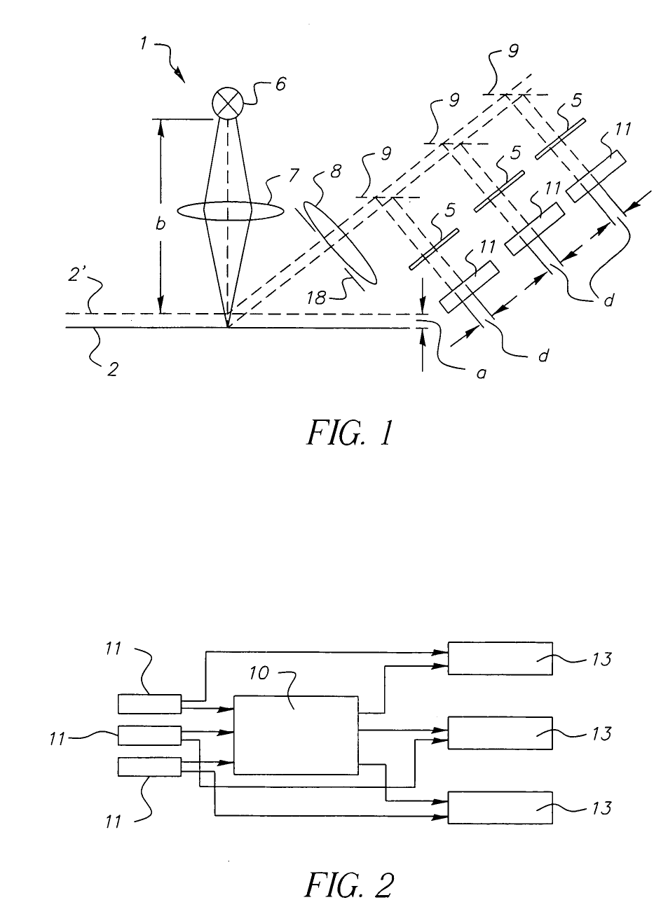

Referring now to the accompanying drawings, FIG. 1 shows a schematic embodiment form of the invention with a sensor device 1, which is placed above a surface 2, 2′. A surface 2, 2′, for example, is a color-bearing print material that is fed through a printing machine. In FIG. 1, the surface 2 is drawn with a straight line depicting the actual position of the surface 2. The dotted line, in contrast, represents the ideal position of surface 2′. The actual position of the surface 2 is displaced downward, while the ideal error-free position represents the non-displaced surface 2′. In the error-free position of surface 2, 2′, colors are accurately measurable on the surface 2, 2′, if the sensor device 1 is calibrated for this distance. If distance b, between a light source 6 and surface 2, 2′, does not correspond to this calibrated distance, the colors on surface 2, 2′ will be inaccurately calculated by sensor device 1.

Light source 6 is placed above surface 2; sensor device 1 includes this source. In this example, light source 6 emits white light in the direction of surface 2. Between light source 6 and surface 2, an initial lens 7 is placed, through which light source 6's white light passes and focuses the beam of light focused at surface 2. From surface 2, 2′, the beam is reflected, passing through a gap 18 and a second lens 8, behind gap 18. The beam of light reflected from surface 2 (the surface present whose location is inaccurate), is depicted in FIG. 1 by dots and dashes. The radiation reflected from surface 2′ (the accurately positioned surface) is depicted with dashes only.

Behind second lens 8, reflectors 9 are placed, that reflect the beam. In this example, three semitransparent reflectors 9 are placed in a row, one behind the other, which reflect a share of the light ray and allow another component to pass through. The reflected shares of the light beam are filtered through respective filters 5, at which color shares are filtered out from the white light, and each reflected share transmits a color component through the particular filter 5. This way, behind each of the filters 5, a color component is available. For example, behind the first filter 5 is a cyan color component; behind the second filter 5, a yellow color share; and behind the third filter 5 a magenta color component. The individual cyan, magenta, and yellow components are then transmitted to a respective sensor receiver 11 that is included in sensor device 1.

A respective sensor receiver 11 is assigned to each filter 5. The sensor receivers 11 include, components such as (position sensing devices, PSD), charge coupled devices (CCD) and diode cells or diode arrays. Position sensors include, such components as photolayers placed between electrodes. Depending on the location of the beam of light (optimally a point of light), the beam of light is incident on the photolayer of sensor receiver 11's position sensor, and a varying photocurrent is generated. Thus, there is a correspondence between the incidence location of the light beam and the photocurrent. The photocurrent is measured and assigned to the incidence location of the light beam.

At the sensor receivers 11, the individual color shares are received, each sensor receivers 11 receiving a color share, cyan, magenta, and yellow. From the beam components, each of the color values is determined by color sensors in respective sensor receivers 11. Therefore, in the present example, the color values for the cyan, magenta and yellow shares of the white light of light source 1, are available. For measurement of complete color information, measurements in at least three spectral color ranges are required, as in the present instance. Further, the positions of the incident light beams are determined in respective sensor receivers 11.

To clarify the principle of positional determination of the incident light beam, the rays at the actual position of surface 2 are depicted with dots and dashes and at the optimal position of surface 2′, they are shown with dashes only. The distance of the two beams of surface 2 and surface 2′, are given as examples, at sensor receivers 11, respectively designated as d. The distance d consequently designates the distance which is recorded by sensor receivers 11 that comes from the positional changes of surface 2, 2′ in relation to light source 6, with light source 6 being encompassed by sensor device 1.

In the current example, the respective distances d, are determined by three sensor receivers 11. Therefore, this distance can be determined in order to decrease measurement inaccuracy. Aided by the distance d of radiation from surface 2′ (having a proper position), and from surface 2 (with a wrong position), the distance a, between these two conditions, can be determined indicating a positional shift of surface 2, 2′.

In summary, sensor receivers 11 can be used to determine the distance a between the surfaces 2 and 2′. Distance a, is approximately equal to distance d, determined by the position-sensitive sensor receivers 11, of the light beams received by them. In a color measurement during the printing process (on-line color measurement), in a printing machine, the distance between sensor device 1 to the measured object (surface 2, 2′) is unknown or varied. This leads to a change in the angular range, in which the light scattered from surface 2, 2′, is measured. A change in the distance between sensor device 1 and surface 2, 2′ also has an effect on the size of the illuminated measurement point on surface 2, 2′.

The distance a to be measured is determined through triangulation. Triangulation is determined using the known lengths and the angle via geometric calculations, specifically the incidence angle and the angle of radiation of the light beam on surface 2, 2′ and the reflectors 9 and the incidence angle of the light beam on the sensor receivers 11. From this distance a, the position error of surface 2, 2′ in the direction of light source 6's light beam, errors result in the determination of the color values. Due to the shift of surface 2′, color values are inaccurately determined by the sensor receivers 11. One alternative to the above description is to use multiple, narrow-band light sources 6. In this alternative, various spectral light shares preferably are emitted one after another or simultaneously, toward the surface. In the example described, a single broadband sensor receiver 11 is used which determines the color values of surface 2, 2′, as well as their position, as described above.

FIG. 2 is a schematic block-diagram depiction of one part of an embodiment form of the invention. Schematic depiction is made of the three sensor receivers 11 according to FIG. 1, which transmit the data regarding distance a, as determined by triangulation, to an allocation table 10, also designated as a lookup table. In allocation table 10, the distance data are assigned a clear correction value with each distance a being assigned a correction value. When it is calibrated, sensor device 1 initially detects the color values for various heights or distances a, of surface 2, 2′ from the correct and incorrect positions. The differing distances a, are known, and are not determined using sensor device 1 during calibration. The color values obtained at the various distances a are compared with the known correct color values. From the comparison of accurate with inaccurate color values at various distances a, correction values are determined. Thus, correction values are available for each distance a, of the displaced surface 2 from the correct position of surface 2′.

At the output of allocation table 10, these correction values are transferred to multiplication elements 13, in which they are multiplied with the particular color values, which are obtained from the sensor receivers 11. Each multiplication element 13 issues a product at its output that results from the multiplication of the correction value by a color value. Consequently, at the outputs of multiplication elements 13, the corrected color values of the individual cyan, magenta and yellow excerpts are available. These have been produced from the inaccurately measured color values, due to the shift of surface 2, 2′ and the amount of the shift of surface 2, 2′, the distance a.

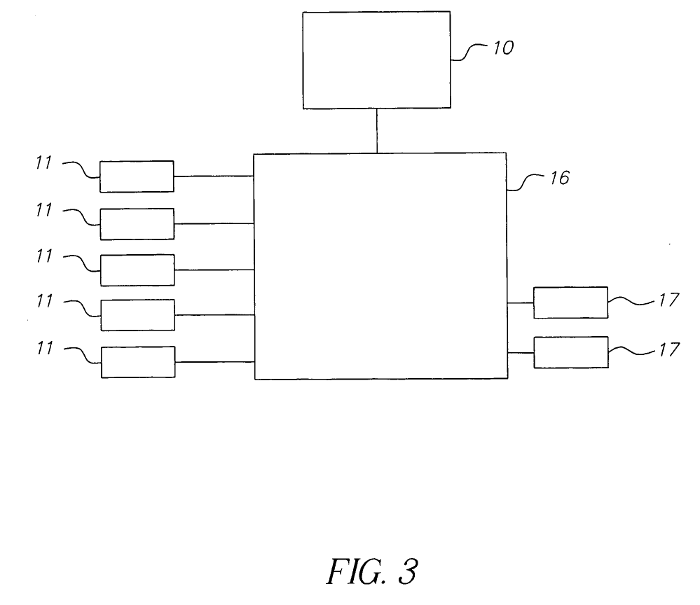

FIG. 3 is a schematic block-diagram depiction of one part of an embodiment form of the invention similar to FIG. 2. Here, by way of example, five sensor receivers 11 are configured, each of which receives a color value of a color excerpt. There can be any number of sensor receivers 11. The outputs of sensor receivers 11 are linked to a computer 16 and the measured color values of the surface 2, 2′, as well as the distance values calculated by the positional shift of surface 2′ to the position of surface 2, are transmitted to this computer. Allocation table 10 is connected to computer 16. For each distance value, a correction value is provided, by which each color value is multiplied. Thus, for each color value (in this FIG. 3 example, five color values, each of which is delivered by a sensor receiver 11), a corrected color value is obtained. Despite the change in distance that distorts color measurement, this value corresponds to the correct color values on surface 2, 2′. At the output of computer 16, an initial readout device 17 is placed that issues the correct color value, as described above under FIG. 2. The correct color value results from the color value measured by sensor device 1, multiplied by a correction value resulting from the distance a determined by sensor device 1. Additionally, a second readout device 17 is provided that issues the computed distance a, as described above. As a result of the device 17's readout of distance a, a positional measurement of surface 2, 2′ in relation to the height of surface 2, 2′, i.e. the position of surface 2, 2′ relative to its perpendicular, is available, in addition to a color measurement of the color of surface 2, 2′.

In another embodiment, a light source 6 with temporally changing spectral characteristics is used. This light source 6 emits light at alternating spectral frequencies to surface 2. For this process, a white light source 6, for example, with a number of replaceable optical filters can be used. Another possibility is the use of several light sources 6 with various spectral frequencies that are switched over consecutively whose emitted light is alternately sent in sequence to surface 2. Such light sources 6 can be coupled in via dielectric filters onto a common optical axis, so that the result is an even impingement of the light onto surface 2. Here sensor receiver 11 includes a single photoreceiver whose output signals are evaluated sequentially in temporal terms, corresponding to the switchovers of light sources 6. Each spectral frequency of light source 6 is evaluated separately by sensor receivers 11. The output signals of sensor receiver 11's photoreceiver are evaluated upon receipt of light from each light source 6, with differing spectral frequencies in another way.

In one beneficial version, sensor receiver 11 includes a photoreceiver with several outputs, such as a photodiode with several segments (a so-called lateral photodiode) that permits simultaneous assessment of the position and intensity of the light reflected from surface 2, 2′.

Additionally, in a special embodiment, the luminous intensity of light source 6 is corrected depending on the distance signal of the distance b, in that a correction signal is assigned to each distance signal in allocation table 10. By altering the luminous intensity of sensor device 1, the color signal received in sensor receiver 11 is changed. With the correction signal from allocation table 10 for correcting the luminous intensity, a color value is obtained from readout device 17, which depends on distance b. If distance b and the correction value for this distance b, relative to the luminous intensity have been determined, then the distance-dependent color value can be determined through sensor device 1, without having to conduct a further distance determination or correct the color value depending on the distance of surface 2 from sensor device 1. Here it is presupposed that the distance from sensor device 1 to surface 2 does not change after determining the correction signal, i.e., the distance a, and the distance b, remain constant. Thus, all sensor device 1 does, determines the color values of surface 2, without determining distance b at each color measurement. Consequently, with this embodiment form, erroneous color values caused by changes in distance are corrected by adjusting the luminous intensity of sensor device 1.

The invention has been described in detail with particular reference to certain preferred embodiments thereof, but it will be understood that variations and modifications can be effected within the spirit and scope of the invention.

What is claimed is:

1. Procedure for detecting various colors on a surface (2), comprising the steps of: detecting at least one color on a surface; detecting the distance between a color sensor device (1) and surface (2); and determining the proper color value of surface (2), depending on the distance of surface (2) from the sensor device (1).

2. Procedure according to claim 1, further comprising the steps of: having the sensor device (1) emit white light to the surface (2); reflecting light from the surface; and spectrally splitting such reflected light by a filter (5) prior to being received by a sensor receiver (11).

3. Procedure according to claim 2, wherein emitted light is temporally sequential light with at least three different spectral properties, and the reflected light is received by the sensor receiver (11).

4. Procedure according to claim 2, wherein the intensity of the light emitted to surface (2) is altered according to correction values dependent on the distance of surface (2) from sensor device (1).

5. Procedure according to claim 2, wherein correction values are determined for the color values from the determined distance between surface (2) and sensor device (1).

6. Sensor device (1), for detection of various colors at a surface, comprising: at least one sensor receiver (11) for determination of a change in distance of sensor device (1) from the surface (2, 2′).

7. Sensor device (1) according to claim 6, further including a distance sensor for determination of the distance between sensor device (1) and surface (2).

8. Sensor device (1) according to claim 7, further including an allocation table (10) for allocation of correction values to distances detected by sensor device (1).

9. Sensor device (1) according to claim 6, said receivers (11) has multiple outputs, whose output signals are evaluated simultaneously with the determination of the luminous intensity and the distance between surface (2) and sensor device (1).

10. Sensor device (1) according to claim 6 further including a light source (6) emitting light to the surface (2) for reflection therefrom, and a filter (5) for spectrally splitting the reflected light prior to being received by said at least one sensor receiver (11).

11. Sensor device (1), according to claim 10, wherein said light source (6) includes a device for controlled alteration of its luminous intensity, depending on the distance of surface (2) from sensor device (1).
